(19) United States
(12) Patent Application Publication
(10) Pub. No.: US 2024/0174026 A1
(43) Pub. Date: May 30, 2024

(54) TWO-PIECE TIRES WITH REPLACEABLE TREAD BELTS AND RELATED METHODS

(71) Applicant: The Goodyear Tire & Rubber Company, Akron, OH (US)

(72) Inventor: Robin Lamgaday, Copley, OH (US)

(21) Appl. No.: 18/060,010

(22) Filed: Nov. 30, 2022

(51) Int. Cl. B60C 11/02; B60C 11/00

(52) U.S. Cl. CPC B60C 11/02; B60C 11/005

(57) ABSTRACT

A two-piece tire of the present disclosure may include a tread belt and a body capable of being connected by a plurality of locking mechanisms. The locking mechanisms may include a protrusion capable of extending into a lockable cavity via an opening defined by a lip that protrudes into the lockable cavity. For an individual locking mechanism, the protrusion may be integral with the tread belt or the body, and the lockable cavity integral to the other.

### FIELD OF THE INVENTION

The present disclosure relates generally to two-piece tires having a body with a replaceable tread belt.

### BACKGROUND OF THE INVENTION

Retreading tires is a means by which to extend the life of a tire as well as to reduce the need for natural rubber and other raw materials. The material cost of retreading a tire can be about 20 percent of making a new tire. Retreading tires also minimizes the amount of waste that ends up in landfills. Tires can be retreaded multiple times if the carcass is in usable condition. Retreaded tires can be prepared, for example, by removing (e.g., via abrading away) a tread from a tire down to a carcass of the tire and buffing the carcass to produce a buffed tire rubber carcass. Then, an uncured rubber layer, also referred to as a “cushion layer,” can be applied to the buffed tire rubber carcass. To the cushion layer, a new pre-cured rubber tread can be applied. Then, the assembly is cured at an elevated temperature to form a cured retreaded rubber tire. In some instances, the assembly can be vacuum sealed before curing to apply pressure to the layers and improve the adhesion between the layers of the final retreaded tire.

### SUMMARY OF THE INVENTION

An example two-piece tire of the present disclosure may comprise: a tread belt and a body connected by a plurality of locking mechanisms, the tread belt comprising a tread at an outer surface of the tread belt, and the body comprising a rubber cap located at an outermost portion of the body along a radial direction of the two-piece tire; wherein each of the plurality of locking mechanisms comprises a protrusion that extends into a lockable cavity via an opening, each lockable cavity being at least partially defined by a lip that protrudes into the lockable cavity; wherein the lip defines the opening of the lockable cavity, wherein, for at least one of the plurality of locking mechanisms, either (i) the protrusion is integral to an inner surface of the tread belt and the lockable cavity is integral to an outer surface of the rubber cap, or (ii) the protrusion is integral to the outer surface of the rubber cap and the lockable cavity is integral to the inner surface of the tread belt; and wherein the inner surface of the tread and the outer surface of the rubber cap form a direct contact interface.

An example body for a two-piece tire of the present disclosure may comprise a rubber cap located in an outermost portion of the body along a radial direction of the two-piece tire, the rubber cap comprising (i) a plurality of protrusions at an outer surface of the rubber cap and integral to the rubber cap, (ii) a plurality of lockable cavities at the outer surface of the rubber cap and integral to the rubber cap, or (iii) a combination of (i) and (ii), wherein each lockable cavity is at least partially defined by a lip that protrudes into the lockable cavity, and wherein the lip defines an opening of the lockable cavity; a supporting carcass positioned inward from the rubber cap along the radial direction; and two sidewalls that extend inward along the radial direction from axial outer edges of the rubber cap.

An example tread belt for a two-piece tire of the present disclosure may comprise an outer surface and an inner surface as opposing surfaces of the tread belt; a tread at the outer surface of the tread belt; and (i) a plurality of protrusions at the inner surface of the tread belt and integral to the tread belt, (ii) a plurality of lockable cavities at the inner surface of the tread belt and integral to the tread belt, or (iii) a combination of (i) and (ii), wherein each lockable cavity is at least partially defined by a lip that protrudes into the lockable cavity, and wherein the lip defines an opening of the lockable cavity.

An example method for constructing a two-piece tire of the present disclosure may comprise applying a force to a tread belt in an outwardly radial direction, the tread belt comprising a tread at an outer surface of the tread belt and a first portion of a plurality of locking mechanisms at an inner surface of the tread belt and integral to the tread belt; positioning a body within a circumference of the tread belt, the body comprising a rubber cap located in an outermost portion of the body facing the inner surface of the tread belt, the rubber cap comprising a second portion of the plurality of locking mechanisms that (a) correspond to the first portion of the plurality of locking mechanisms, (b) are at an outer surface of the rubber cap, and (c) are integral to the rubber cap; wherein each of the plurality of locking mechanisms comprises a protrusion capable of extending into a lockable cavity via an opening, each lockable cavity being at least partially defined by a lip that protrudes into the lockable cavity, the lip defining the opening of the lockable cavity; wherein, for at least one of the plurality of locking mechanisms, (i) the first portion is the protrusion and the second portion is the lockable cavity or (ii) the first portion is the lockable cavity and the second portion is the protrusion; aligning the first and second portions of the plurality of locking mechanisms; removing the force so as to cause the protrusion to extend into the lockable cavity and the inner surface of the tread belt to engage the outer surface of the rubber cap to form a direct contact interface therebetween.

### Definitions

The following definitions are applicable to the present invention.

“Axial” and “axially” mean lines or directions that are parallel to the axis of rotation of the tire.

“Groove” means an elongated void area in a tread that may extend in a circumferential, lateral or angled manner about the tread in a straight, curved, or zigzag configuration. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves have substantially reduced depth as compared to wide circumferential grooves which the interconnect, they are regarded as forming “stiffener elements” tending to maintain a rib-like character in tread region involved.

“Inner” means toward the inside of the tire.

“Lateral” and “laterally” are used to indicate axial directions across the tread of the tire.

“Normal inflation pressure” refers to the specific design inflation pressure and load assigned by the appropriate standards organization for the service condition for the tire.

“Outer” means toward the outside of the tire.

“Radial” and “radially” are used to mean directions radially toward or away from the axis of rotation of the tire.

“Tread” means a molded rubber component which includes that portion of the tire that comes into contact with the road when the tire is normally inflated and under normal load. The tread has a depth conventionally measured from the tread outer surface to the bottom of the deepest groove of the tire.

“Tread block” or “tread element” or “traction element” means a rib or a block element defined by a shape having adjacent grooves.

### BRIEF DESCRIPTION OF THE DRAWINGS

The invention will be described by way of example and with reference to the accompanying drawings.

FIGS. 1A and 1B illustrate radial cross-sectional views of nonlimiting examples of a tread belt and a body of a two-piece tire in separated and engaged configurations, respectively.

FIGS. 2A through 2E illustrate radial cross-sectional views of nonlimiting examples of lockable cavities.

FIGS. 3A through 3D illustrate radial cross-sectional views of nonlimiting example protrusions.

FIGS. 4A through 4D illustrates planar views of at least some of the steps in a nonlimiting example method for assembling a two-piece tire of the present disclosure.

### DESCRIPTION

The present disclosure relates generally to two-piece tires having a body with a replaceable tread belt. More specifically, the two-piece tires of the present disclosure utilize a primarily mechanical locking mechanism to secure a seamless tread belt to the body so that the cushion layer or other adhesives are not needed between the tread belt and the body. For example, the locking mechanism for the two-piece tires of the present disclosure can utilize a protrusion on the body and a lockable cavity in the tread belt (or a protrusion on the tread belt and a lockable cavity in the tread body) that engage and lock together. The locking mechanisms described herein, in combination with the natural tack between the body and the tread belt as well as the air pressure from the inflated two-piece tire, is believed to secure the tread belt to the body without the inclusion of the cushion layer.

Because no cushion layer is used, the tread belt of the two-piece tires of the present disclosure may be removed from the body without the abrading, buffing, and curing steps of traditional retreading. Eliminating the additional steps may extend the life of the body and reduce the rubber waste associated with retreading. Further, eliminating the additional steps present in traditional retreading may enable a technician to retread the body of a two-piece tire of the present disclosure on-site at a tire shop while a customer waits.

Because the tread belt is all that is being replaced when retreading a two-piece tire of the present disclosure, the cost may be lower to the customer than the cost of traditional retreaded tires. Further, the straightforward retreading of the two-piece tires of the present disclosure may also allow for on-demand retreading for reasons other than worn tread, which may include retreading to a different tread block to improve tire performance or in response to environmental conditions. For example, retreading from a summer tread to a winter tread, and vice versa, in response to seasonal changes may be readily accomplished with the two-piece tires of the present disclosure.

Generally, the two-piece tires of the present disclosure include a plurality of locking mechanism that, when engaged, secure the tread belt to the body. An individual locking mechanism includes a protrusion as part of the tread belt and a lockable cavity as part of the body or vice versa. When engaged, the protrusion extends into the lockable cavity. For a two-piece tire, the plurality of locking mechanisms may include (i) one or more locking mechanisms with the protrusion as part of the tread belt and the lockable cavity as part of the body, (ii) one or more locking mechanisms with the protrusion as part of the body and the lockable cavity as part of the tread belt, or (iii) a combination of (i) and (ii).

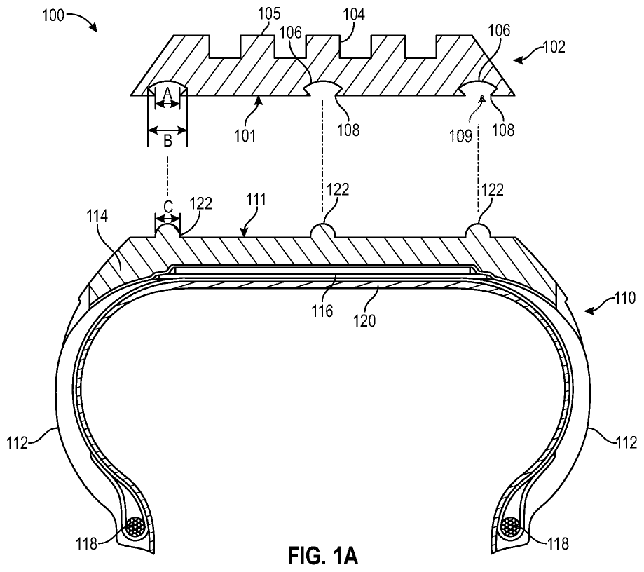

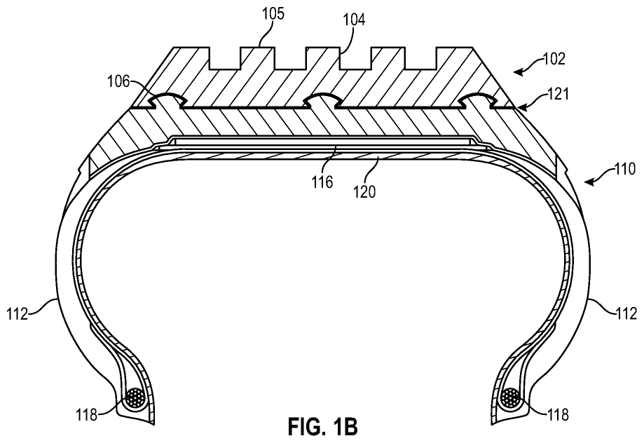

FIGS. 1A and 1B illustrate radial cross-sectional views of a nonlimiting example of a pre-cured tread belt 102 and a pre-cured body 110 of a two-piece tire 100 according to the present disclosure in a separated configuration and an engaged configuration, respectively. The body 110 can include two sidewalls 112, a rubber cap 114, a supporting carcass 116, inextensible beads 118, and a rubber innerliner 120 (or barrier layer). The rubber cap 114 is located in the outermost portion of the body 110 and can abut the supporting carcass 116 and extend radially outward from the supporting carcass 116. The individual sidewalls 112 can extend radially inward from the axial outer edges of the rubber cap 114 to join the respective inextensible beads 118. The supporting carcass 116 can act as a supporting structure for the rubber cap 114 and sidewalls 112. The rubber innerliner 120 can be positioned radially inward from the supporting carcass 116 and axially inward from each of the sidewalls 112.

The tread belt 102 can be a seamless structure that includes a tread 104 (adapted to be ground contacting when the tire 100 is in use) at a ground contact surface 105 (e.g., constituting the radially outer surface of the tread belt 102) of the tread belt 102. Further, the tread belt 102 can comprise a plurality of lockable cavities 106 open to an inner surface 101 of the tread belt 102. In various embodiments, the inner surface 101 can comprise one or more lips 108 that protrudes into one or more of the respective lockable cavities 106. For example, the one or more lips 108 can define an opening 109 of the lockable cavities 106 at the inner surface 101, where a diameter A of the opening 109 at the inner surface 101 can be smaller than a maximum diameter B of a portion of the lockable cavities 106 defined within the tread belt 102 (e.g., as shown in FIG. 1). The lip 108 may have a flat surface (e.g., parallel to the inner surface-side of the opening 109) or a sloped surface inside the cavity 106 (or at the cavity-side of the opening 109). Said sloped surface may facilitate separation of the tread belt 102 and the body 110. Further, lip 108 may have a flat surface (e.g., parallel to the inner surface-side of the opening 109) or a sloped surface at the inner surface 101 of the tread belt 102 (or at the inner surface-side of the opening 109). Said sloped surface may facilitate insertion of the protrusion 122 into the cavity 106 when assembling the tread belt 102 and the body 110.

The lockable cavities 106, as illustrated, have a minor-arc cross-sectional shape. However, the lockable cavities 106 may have other cross-sectional shapes (e.g., polygonal and/or arc cross-sectional shapes). The cross-sectional shapes and dimensions of the lockable cavities 106 are described in more detail below.

The rubber cap 114 includes a plurality of protrusions 122 extending from a radially outer surface 111 of the rubber cap 114. The protrusions 122 (i) locationally correspond to the lockable cavities 106 of the tread belt 102 as the other half of each locking mechanism and (ii) are integral to the rubber cap 114. For example, the positioning of the plurality of protrusions 122 on the radially outer surface 111 can complement the arrangement of the lockable cavities 106 in the tread belt 102 when the tread belt 102 is positioned adjacent to the rubber cap 114 for assembly of the two-piece tire 100. The protrusions 122 have a maximum diameter C.

When the tread belt 102 and the body 110 are engaged (FIG. 1B), the inner surface 101 of the tread belt 102 engages the outer surface 111 of the rubber cap 114 at a direct contact interface 121 (e.g., a region of connection between the outer surface 111 and the inner surface 101), and the protrusions 122 extend into the lockable cavities 106. The interface 121 preferably does not include adhesives. For example, interface 121 can be a direct contact between the outer surface 111 and the inner surface 101. For instance, the outer surface 111 can complement the inner surface 101, and vice versa. Rather, the natural tack between the composition of the tread belt 102 and the composition of the rubber cap 114, as well as the protrusions 122 extended into the lockable cavities 106, secure the tread belt 102 to the body 110.

Preferably, the protrusions 122 are formed of a deformable material so that, when the tread belt 102 and the body 110 are engaged and at normal inflation pressure, the protrusions 122 at least substantially fill the corresponding lockable cavity 106 (e.g., fill at least 90 volume percent, and preferably at least 95 volume percent, of the corresponding lockable cavity 106). This deformation, as well as the lip 108, may act to secure the tread belt 102 to the body 110 during use of the two-piece tire 100.

The protrusions 122 and corresponding lockable cavities 106 should be appropriately shaped so that (i) the protrusions 122 can enter the corresponding lockable cavities 106 with minimal to no damage to the protrusions 122; and (ii) when the tread belt 102 and the body 110 are engaged and at normal inflation pressure, the protrusions 122 at least substantially fill the corresponding lockable cavity 106. Therefore, while FIG. 1A illustrates the maximum diameter B of the lockable cavity 106 as being larger than the maximum diameter C of the protrusion 122, in alternative embodiments the maximum diameter B of the lockable cavity 106 may be equal to or smaller than the maximum diameter C of the protrusion 122. Additionally, the maximum diameter C of the protrusion 122 may be equal to, smaller than, or larger than the diameter A of the opening 109. When the maximum diameter C of the protrusion 122 is larger than the diameter A of the opening 109 and/or when the maximum diameter B of the lockable cavity 106 is smaller than the maximum diameter C, the shape and material composition of the protrusion 122 should be sufficiently deformable and the composition of the lip 108 should be sufficiently rigid to allow the protrusion 122 to pass through the opening 109 (e.g., around the lip 108) and to at least substantially fill the corresponding lockable cavity 106.

Further, in the illustrated image, in some embodiments, each protrusion 122 has an arc radial cross-sectional shape (e.g., semi-circle (180° arc), minor-arc (less than 180° arc), or major-arc (greater than 180° arc)) similar to the radial cross-sectional shape of the corresponding lockable cavity 106, but without an indentation to correspond to the lip 108 of the protrusion. However, this is not a requirement. The protrusions 122 should be shaped to allow for the protrusions 122 to at least substantially fill the corresponding lockable cavities 106 when the tread belt 102 and the body 110 are engaged and at normal inflation pressure.

While FIGS. 1A and 1B illustrate the protrusions 122 as integral with the rubber cap 114 and the corresponding lockable cavities 106 as integral with the tread belt 102, in alternative embodiments, the locking mechanisms may include the protrusions as integral with the tread belt and the corresponding lockable cavities as integral with the rubber cap. Further, some of the plurality of locking mechanisms may be configured with the protrusions as integral with the tread belt and the corresponding lockable cavities as integral with the rubber cap while other locking mechanisms on the same two-piece tire may be configured with the protrusions as integral with the rubber cap and the corresponding lockable cavities as integral with the tread belt.

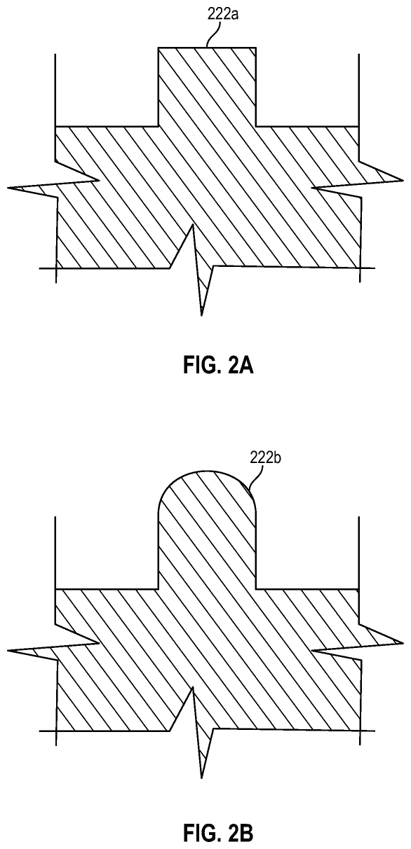

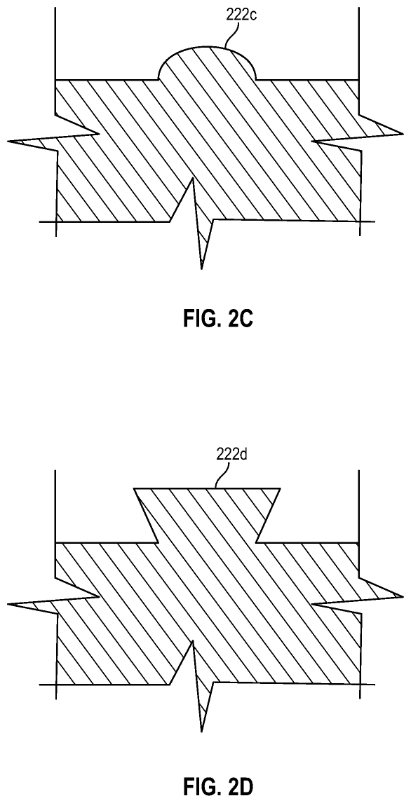

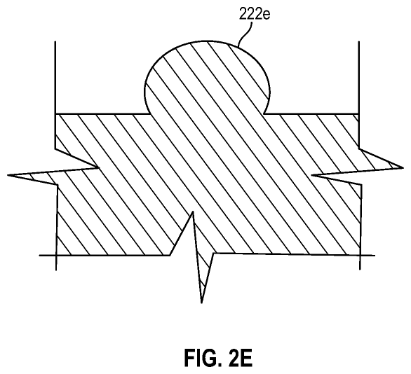

In any embodiment, the protrusions of the locking mechanism may have various polygonal and/or arc cross-sections. FIGS. 2A through 2E illustrate radial cross-sectional views of nonlimiting example protrusions 222. The example protrusions 222 or any other cross-sectional shape may be used for protrusions that are part of the rubber cap (e.g., the rubber cap 114 of FIG. 1) or for protrusions that are part of the tread belt. FIG. 2A illustrates a radial cross-sectional view of a first example protrusion 222a having a rectangular-shaped cross-section. FIG. 2B illustrates a radial cross-sectional view of a second example protrusion 222b having a rounded-top, rectangular-shaped cross-section. FIG. 2C illustrates a radial cross-sectional view of a third example protrusion 222c having a semi-circle-shaped (or minor-circle-shaped, if less than a 180° arc) cross-section. FIG. 2D illustrates a radial cross-sectional view of a fourth example protrusion 222d having a trapezoidal-shaped cross-section. FIG. 2E illustrates a radial cross-sectional view of a fifth example protrusion 222e having a major-arc-shaped cross-section.

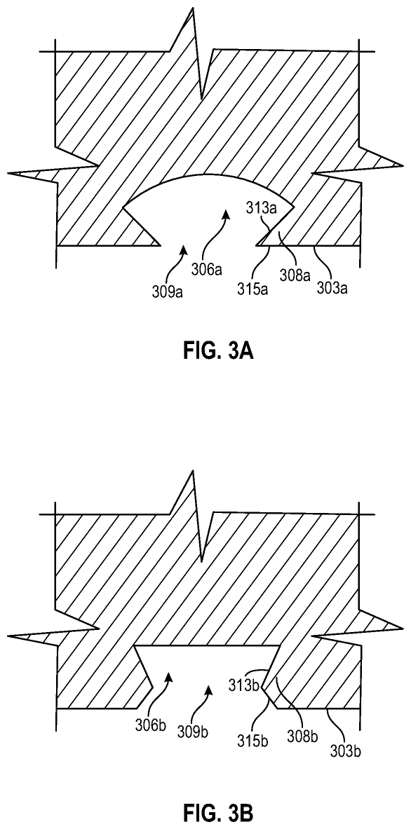

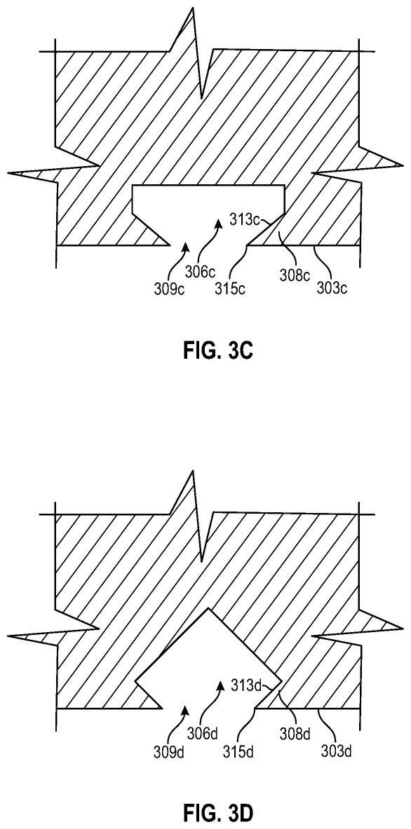

In any embodiment, the lockable cavities of the locking mechanism may have various polygonal and/or arc cross-sections. FIGS. 3A through 3D illustrate radial cross-sectional views of nonlimiting examples of lockable cavities 306. The example lockable cavities 306 or any other cross-sectional shape may be used for lockable cavities that are part of the rubber cap or for protrusions that are part of the tread belt (e.g., the tread belt 102 of FIG. 1). FIG. 3A illustrates a radial cross-sectional view of a first example lockable cavity 306a having a minor-arc-shaped cross-section and an opening 309a that is at least partially defined by a lip 308a. The lip 308a has a sloped surface 313a inside the cavity 306a and a flat surface 315a at a surface 303a (e.g., an inner surface of a tread belt or an outer surface of a rubber cap). FIG. 3B illustrates a radial cross-sectional view of a second example cavity 306b having a trapezoidal-shaped cross-section and an opening 309b that is at least partially defined by a lip 308b. The lip 308b has a sloped surface 313b inside the cavity 306b and a sloped surface 315b at a surface 303b (e.g., an inner surface of a tread belt or an outer surface of a rubber cap). FIG. 3C illustrates a radial cross-sectional view of a third example lockable cavity 306c having a squared-trapezoidal-shaped cross-section and an opening 309c that is at least partially defined by a lip 308c. The lip 308c has a sloped surface 313c inside the cavity 306c and a flat surface 315c at a surface 303c (e.g., an inner surface of a tread belt or an outer surface of a rubber cap). FIG. 3D illustrates a radial cross-sectional view of a fourth example of a lockable cavity 306d having a diamond-shaped cross-section and an opening 309d at least partially defined by a lip 308d. The lip 308d has a sloped surface 313d inside the cavity 306d and a flat surface 315d at a surface 303d (e.g., an inner surface of a tread belt or an outer surface of a rubber cap).

For a two-piece tire of the present disclosure, all of the lockable cavities of the plurality of locking mechanisms may have the same, similar, or substantially the same shape and/or dimensions. Alternatively, two or more of the lockable cavities of the plurality of locking mechanisms have a different architecture and/or dimensions.

Any lockable cavity shape may pair with any protrusion shape, provided the protrusions at least substantially fill (e.g., fill at least 90 volume percent (preferably at least 95 volume percent)) the corresponding lockable cavity when the tread belt and the body are engaged and at normal inflation pressure.

The two-piece tires of the present disclosure may have any suitable number of locking mechanisms (or protrusions and corresponding lockable cavities) (e.g., about 10 to about 10,000 or more, or about 10 to about 100, or about 50 to about 250, or about 200 to about 600, or about 500 to about 5000, or about 1000 to about 10,000). The number of locking mechanisms (or protrusions and corresponding lockable cavities) may depend on the size of the protrusions and corresponding lockable cavities as well as the size of the body and the tread belt. In preferred embodiments, the number of locking mechanisms (or protrusions and corresponding lockable cavities) should be such as to provide stability to the replacement tread to enable the retreaded tire to be usable for its desired useful life.

The locking mechanisms (or protrusions and corresponding lockable cavities) can be arranged in any pattern (e.g., one or more straight lines along the circumference of the body and the tread belt, respectively; a hexagonal close-packed pattern; and the like).

A spacing between the protrusions and a spacing between the lockable cavities may be any suitable value for forming a functioning tire having a tread belt locked with a body. For example, the spacing between the protrusions may be about 0.5 cm to about 10 cm (or about 0.5 cm to about 2 cm, or about 1 cm to about 5 cm, or about 3 cm to about 7 cm, or about 5 cm to about 10 cm). For example, the spacing between the lockable cavities may be about 0.5 cm to about 10 cm (or about 0.5 cm to about 2 cm, or about 1 cm to about 5 cm, or about 3 cm to about 7 cm, or about 5 cm to about 10 cm). Dimensions outside the foregoing example ranges may be used.

The maximum diameter of a protrusion may be any suitable value for forming a functioning locking mechanism. For example, the maximum diameter of a protrusion may be about 0.5 cm to about 3 cm (or about 0.5 cm to about 2 cm, or about 1 cm to about 3 cm). Dimensions outside the foregoing example ranges may be used.

The diameter of an opening of a lockable cavity may be any suitable value for forming a functioning locking mechanism. For example, the diameter of an opening of a lockable cavity may be about 0.5 cm to about 2 cm (or about 0.5 cm to about 1 cm, or about 1 cm to about 2 cm). Dimensions outside the foregoing example ranges may be used.

The maximum diameter of a lockable cavity may be any suitable value for forming a functioning locking mechanism. For example, the maximum diameter of a lockable cavity may be about 0.6 cm to about 3 cm (or about 0.6 cm to about 1 cm, or about 1 cm to about 2 cm, or about 2 cm to about 3 cm). Dimensions outside the foregoing example ranges may be used.

The maximum depth of a lockable cavity (from the inner surface of the tread belt radially inward to the deepest part of the lockable cavity) may be any suitable value for forming a functioning locking mechanism. For example, the maximum depth of a lockable cavity may be about 0.5 cm to about 3 cm (or about 0.5 cm to about 2 cm, or about 1 cm to about 3 cm). Dimensions outside the foregoing example ranges may be used.

The two-piece tires of the present disclosure may have protrusions and corresponding cavities other than the locking mechanisms described herein. These additional protrusions with corresponding cavities may be lockable with a cavity comprising a lip or configured to engage a cavity without locking (e.g., the cavity not having a lip and referred to as non-locking cavities). For example, a groove may be present as an additional cavity along the inner surface of the tread belt with a corresponding protrusion extending from the outer surface of the rubber cap (or vice versa with the groove in the outer surface of the rubber cap). Said additional cavity and corresponding protrusion may be used as a guide to assist with proper alignment of the locking mechanisms described herein and/or to improve the integrity of the two-piece tire or component thereof.

Because the protrusions and lockable cavities of the locking mechanisms are integral with the respective component of the tire (e.g., the tread belt or the body), the protrusions and lockable cavities may be formed when molding the said components. For example, a mold used to form a tread belt may be shaped to include the desired dimensions and shapes for the tread at the ground contact surface as well as any protrusions and/or lockable cavities at the inner surface of the tread belt. Similarly, a mold used to form a rubber cap may be shaped to include the desired dimensions and shapes for the rubber cap and any protrusions and/or lockable cavities at the inner surface of the tread belt radially outer surface of the rubber cap.

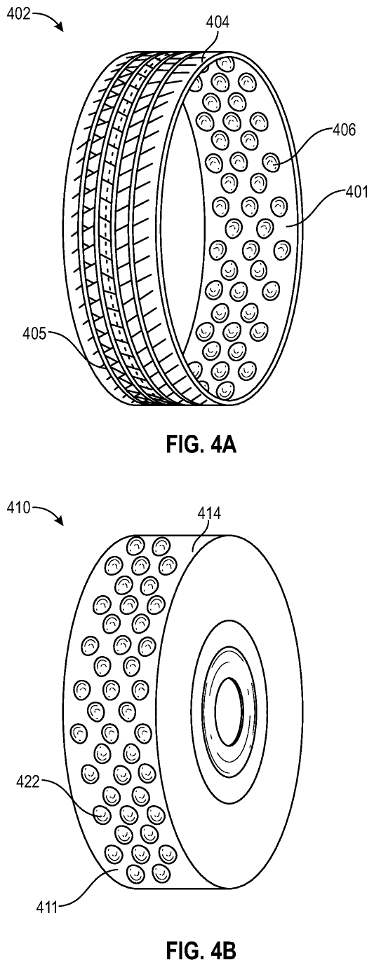

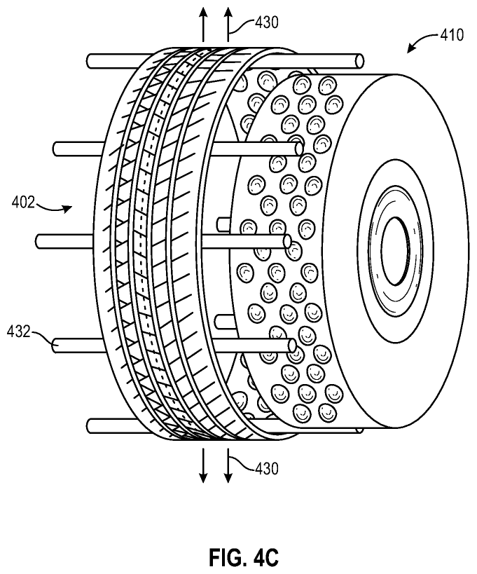

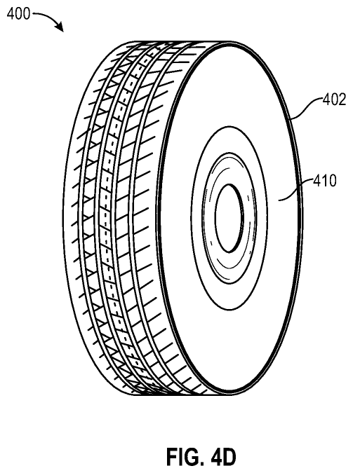

FIGS. 4A through 4D illustrates planar views of at least some of the steps in a nonlimiting example method for assembling a two-piece tire 400 of the present disclosure. The example method may be used to assemble the two-piece tire 100 of FIGS. 1A and 1B or any other two-piece tire of the present disclosure. Further, the two-piece tire 100 of FIGS. 1A and 1B and any other two-piece tire of the present disclosure may be produced by other methods.

FIG. 4A illustrates a pre-cured, seamless tread belt 402 for the two-piece tire 400, the tire belt 402 having a tread 404 at a ground surface 405 (e.g., a radially outer surface of the tread belt 402) and lockable cavities 406 that open to an inner surface 401 of the tread belt 402. FIG. 4B illustrates a corresponding pre-cured body 410 for the two-piece tire 400. The body 410 can include a rubber cap 414, which can include protrusions 422 extending from the radially outer surface 411 of the rubber cap 414, where the protrusions 422 locationally correspond to the lockable cavities 406.

As described herein, alternate embodiments may include protrusions extending from the inner surface 401 of the tread belt 402 and lockable cavities in the rubber cap 414 of the body 410. Further, the plurality of locking mechanisms may include some locking mechanisms as shown in FIGS. 4A and 4B and some locking mechanisms according to the foregoing alternate embodiment.

The tread belt 402 can then be stretched 430 (stretched tread belt 402′ shown in FIG. 4C) radially outwardly at several locations so that the stretched tread belt 402′ is enlarged to a size sufficient to surround the body 410 within the circumference of the stretched tread belt 402′. As illustrated in FIG. 4C, several rods 432 are used to apply force to the tread belt 402 in a radially outward direction. Said rods 432 may be a portion of an apparatus that applies said force. For example, the apparatus can comprise eight rods 432, as shown in FIG. 4C; however, embodiments utilizing more or less rods 432 to facilitate the radial expansion of the tread belt 402 are also envisaged.

The body 410 and the stretched tread belt 402′ can then be positioned so that the body 410 is within the circumference of the stretched tread belt 402′. The protrusions 422 and the lockable cavities 406 can also be aligned. The alignment may be achieved using the protrusions 422 and the lockable cavities 406 alone or augmented by other features (e.g., markings, other cavities and protrusions as described above, and the like) on the body 410 and the stretched tread belt 402′. Alignment may optionally be laser-guided and/or computer operated. The alignment and positioning of the body 410 and the stretched tread belt 402′ may occur in sequence and/or simultaneously.

Once properly aligned, the circumference of the stretched tread belt 402′ may be reduced, thereby causing (i) the inner surface 401 of the tread belt 402 to engage the outer surface 411 of the rubber cap 414 and (ii) the protrusions 422 to extend into the lockable cavities 406. Once the radially outward force is removed (and any components assisting with said force), the result is a two-piece tire 400 of various embodiments described herein.

In use, the two-piece tire 400 can be inflated to a normal inflation pressure, which may increase the adhesion (or tack) between the inner surface 401 of the tread belt 402 to engage the outer surface 411 of the rubber cap 414 (e.g., enhance the interface) and may further deform the protrusions 422 in the lockable cavities 406, which may further secure the body 410 and the tread belt 402.

Because the compositions of the body 410 and the tread belt 402 are pre-cured compositions, the method does not require a curing step.

Removing a tread belt from a body of a two-piece tire of the present disclosure may essentially be the foregoing process in reverse. For example, the two-piece tire can be deflated. Then, one or more portions of the tread belt may be separated from the body a sufficient amount to allow for a tool(s) (e.g., rod(s)) to be inserted between the tread belt and the body. A radially outward force may then be applied to one or more portions of the tread belt. Then, the tread belt and the body may be set apart. Removal in such a manner may allow for the tread belt to be reused. For example, if the tread belt is being changed from a tread belt having a summer tread block (a summer tread belt) to a tread belt having a winter tread block (a winter tread belt), then the summer tread belt, provided the tread thereof is structurally sound, may be properly stored to be exchanged for the winter tread belt at a later time.

In instances where the tread belt is sufficiently worn, once the tread belt and the body are sufficiently separated in a location, the tread belt may be cut laterally and the tread belt removed (e.g., peeled) from the body. Care should be taken to not damage the body in said cutting.

The two-piece tires of the present disclosure may be useful pneumatic tires in applications like micro-mobility tires (e.g., for small autonomous vehicles), passenger tires, and commercial tires (or truck) tires.

Micro-mobility applications include, for example, small autonomous vehicles or robots that move at a slow speed and in environments where tread wear and puncture are of less concern. Therefore, the tread belt for two-piece micro-mobility tires may be a polyurethane or a rubber. For passenger two-piece tires and commercial two-piece tires where wear and puncture are of greater concern, the tread belt is preferably a rubber (examples described further herein).

Examples of rubbers suitable for the tread belt of the two-piece tires of the present disclosure may include, but are not limited to, neoprene (polychloroprene), polybutadiene (including cis-1,4-polybutadiene), polyisoprene (including cis-1,4-polyisoprene) (natural or synthetic), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM) (e.g., ethylene/propylene/dicyclopentadiene terpolymers), alkoxy-silyl end functionalized solution polymerized polymers (SBR, PBR, IBR and SIBR), silicon-coupled, tin-coupled star-branched polymers, the like, and any combination thereof.

The foregoing rubbers may also contain conventional rubber compounding ingredients including processing oil, accelerators, conventional sulfur curing agents, pigments, carbon black, zinc oxide, stearic acid, tackifying resin, and plasticizer.

The tread belt of the two-piece tires of the present disclosure may have a maximum thickness from a radially outer surface of the tread belt to a radially inner surface of the tread belt of any suitable value for forming a functioning tire having a tread belt locked with a body. For example, the tread belt of the two-piece tires of the present disclosure may have a maximum thickness from a radially outer surface of the tread belt to a radially inner surface of the tread belt of about 3 cm to about 10 cm (or about 3 cm to about 6 cm, or about 5 cm to about 10 cm). Dimensions outside the foregoing example ranges may be used.

The tread of the tread belt of the two-piece tires of the present disclosure may have any desired tread block. For example, the tread block may be suitable for a summer tire, a winter tire, an all-season tire, or the like.

The rubber cap in the body piece of the two-piece tires of the present disclosure may be any suitable rubber. Examples of such rubbers include those described herein relative to the tread belt. The rubber cap and the tread belt may have the same composition or different compositions.

The other components in the body piece of the two-piece tires of the present disclosure (e.g., sidewalls, inextensible bead, rubber innerliner, and other components) may be generally selected from those conventionally known in the art.

The supporting carcass of the body piece of the two-piece tires of the present disclosure may be a rubberized ply having a plurality of substantially parallel carcass reinforcing members (not illustrated) made of material like polyester, rayon, or similar suitable organic polymeric compounds. The supporting carcass generally may be any conventional tire carcass for use in pneumatic tires. For example, the supporting carcass can include one or more layers of plies and/or cords to act as a supporting structure for the rubber cap and sidewalls.

The rubber innerliner may be any known rubber innerliner for use in pneumatic tires. In one example, the rubber innerliner can be a sulfur curative-containing halobutyl rubber composition of a halobutyl rubber such as, for example: chlorobutyl rubber or bromobutyl rubber. Such halobutyl-rubber-based innerliner may also contain one or more sulfur-curable diene-based elastomers such as, for example: cis 1,4-polyisoprene natural rubber, cis 1,4-polybutadiene rubber and styrene/butadiene rubber, a combination thereof, and/or the like. The innerliner is normally prepared by conventional calendering or milling techniques to form a strip of uncured compounded rubber of appropriate width.

The rubber innerliner may be replaced with a barrier layer, in some embodiments. Alternatively, a barrier layer may be used in combination with a rubber innerliner. When used together, the rubber innerliner is typically outward relative to the barrier layer. The barrier layer can define a thermoformable film of polymeric material, which can be conforming, can have essentially no memory, and/or can be non-elastomeric. Furthermore, the barrier layer can resist melting at cure temperatures. In one example, the barrier layer includes a thermoformable film of nylon or blend of nylon and rubber. Examples of nylons which may be formed into the thermoformable film of the barrier layer can include, but are not limited to: linear polycondensates of lactams of 6 to 12 carbon atoms, and conventional polycondensates of diamines, dicarboxylic acids (e.g., nylon 6,6; nylon 6,8; nylon 6,9; nylon 6,10; nylon 6,12; nylon 8,8 and/or nylon 12,12), a combination thereof, and/or the like. Further examples include, but are not limited to: nylon 6, nylon 11, and/or nylon 12, which are manufactured from the corresponding lactams. Suitable nylon thermoformable films include, but are not limited to, DARTEK™ films available from DuPont of Wilmington, Delaware. In addition, the polymeric material of the thermoformable films may include, but are not limited to: polycondensates of aromatic dicarboxylic acids, e.g., isophthalic acid or terephthalic acid, with diamines, e.g., hexamethylenediamine, or octamethylenediamine, polycarbonates of aliphatic starting materials, e.g., m- and p-xylylenediamines, with adipic acid, suberic acid and sebacic acid, and polycondensates based on alicyclic starting materials, e.g. cyclohexanedicarboxylic acid, cyclohexanediacetic acid, 4,4′-diaminodicyclohexylmethane and 4,4′-diaminodicyclohexylpropane. The rubber used in the blend may include a natural and/or synthetic rubber. In one or more examples, the rubber includes butyl rubber, styrene butadiene rubber, and/or natural rubber.

Further, the body of the two-piece tires of the present disclosure may have other configurations and/or components than illustrated in FIG. 1A. For example, a sealing layer with self-sealing properties (e.g., described in U.S. Patent Application Publication No. 2016/0101657, incorporated herein by reference) may be included in a body of the two-piece tires of the present disclosure. Said sealing layer may be between the supporting carcass and the rubber innerliner or between the supporting carcass and the barrier layer. One skilled in the art will recognize the components that can be included in the body of the two-piece tires of the present disclosure and any modifications necessary to provide for the rubber cap that includes protrusions and/or lockable cavities as described herein.

### ADDITIONAL EMBODIMENTS

Embodiment 1. A two-piece tire comprising: a tread belt and a body connected by a plurality of locking mechanisms, the tread belt comprising a tread at an outer surface of the tread belt, and the body comprising a rubber cap located at an outermost portion of the body along a radial direction of the two-piece tire; wherein each of the plurality of locking mechanisms comprises a protrusion that extends into a lockable cavity via an opening, each lockable cavity being at least partially defined by a lip that protrudes into the lockable cavity; wherein the lip defines the opening of the lockable cavity, wherein, for at least one of the plurality of locking mechanisms, either (i) the protrusion is integral to an inner surface of the tread belt and the lockable cavity is integral to an outer surface of the rubber cap or (ii) the protrusion is integral to the outer surface of the rubber cap and the lockable cavity is integral to the inner surface of the tread belt; and wherein the inner surface of the tread and the outer surface of the rubber cap form a direct contact interface.

Embodiment 2. The two-piece tire of Embodiment 1, wherein each of the plurality of protrusions fill at least 90 percent of a volume each of the plurality of lockable cavities corresponding thereto.

Embodiment 3. The two-piece tire of any one of Embodiments 1 and 2, wherein no adhesive is present at the direct-contact interface.

Embodiment 4. The two-piece tire of any one of Embodiments 1 through 3, wherein, for at least one of the plurality of locking mechanisms, the lockable cavity has a radial cross-sectional shape of: a minor-arc, a semi-circle, a major-arc, a trapezoid, a squared-trapezoid, or a diamond.

Embodiment 5. The two-piece tire of any one of Embodiments 1 through 4, wherein, for at least one of the plurality of locking mechanisms, the protrusion has a radial cross-sectional shape, when separated from the tread belt, of: a minor-arc, a semi-circle, a major-arc, a rectangle, a rounded-rectangle, or a trapezoid.

Embodiment 6. The two-piece tire of any one of Embodiments 1 through 5, wherein a number of the plurality of locking mechanisms is 10 to 10,000.

Embodiment 7. The two-piece tire of any one of Embodiments 1 through 6, wherein the plurality of locking mechanisms are arranged in a pattern that comprises one or more straight lines along the circumference of the body and the tread belt and/or a hexagonal close-packed pattern.

Embodiment 8. The two-piece tire of any one of Embodiments 1 through 7, wherein a spacing between the protrusions is 0.5 cm to 10 cm.

Embodiment 9. The two-piece tire of any one of Embodiments 1 through 8, wherein a spacing between the lockable cavities is 0.5 cm to 10 cm.

Embodiment 10. The two-piece tire of any one of Embodiments 1 through 9, wherein a maximum diameter of the protrusion is 0.5 cm to 3 cm.

Embodiment 11. The two-piece tire of any one of Embodiments 1 through 10, wherein a diameter of an opening of the lockable cavity is 0.5 cm to 2 cm.

Embodiment 12. The two-piece tire of any one of Embodiments 1 through 11, wherein a maximum diameter of the lockable cavity is 0.6 cm to 3 cm.

Embodiment 13. The two-piece tire of any one of Embodiments 1 through 12, wherein a maximum depth of the lockable cavity is 0.5 cm to 3 cm.

Embodiment 14. The two-piece tire of any one of Embodiments 1 through 13, wherein the tread belt has a maximum thickness of about 1 inch to about 3 inches.

Embodiment 15. The two-piece tire of any one of Embodiments 1 through 14, wherein the tread has a summer tread block, a winter tread block, or an all-season tread block.

Embodiment 16. The two-piece tire of any one of Embodiments 1 through 15, wherein the tread belt and the body are further connected by a plurality of non-locking mechanisms at the direct contact interface.

Embodiment 17. The two-piece tire of any one of Embodiments 1 through 16, wherein the body further comprises: a supporting carcass positioned inward along the radial direction from the rubber cap and abutting the rubber cap, two sidewalls that extend inward along the radial direction from axial outer edges of the rubber cap, and a rubber innerliner positioned inward along the radial direction from the supporting carcass and inward along an axial direction of the two-piece tire from the two sidewalls.

Embodiment 18. The two-piece tire of Embodiment 17, wherein the body further comprises a sealing layer between the supporting carcass and the rubber innerliner.

Embodiment 19. The two-piece tire of any one of Embodiments 1 through 16, wherein the body further comprises a supporting carcass positioned inward along the radial direction from the rubber cap and abutting the rubber cap, two sidewalls that extend inward along the radial direction from axial outer edges of the rubber cap, and a barrier layer positioned inward along the radial direction from the supporting carcass and inward along an axial direction along an axial direction of the two-piece tire from the two sidewalls.

Embodiment 20. The two-piece tire of Embodiment 19, wherein the body further comprises a sealing layer between the supporting carcass and the barrier layer.

Embodiment 21. A body for a two-piece tire comprising: a rubber cap located in an outermost portion of the body along a radial direction of the two-piece tire, the rubber cap comprising (i) a plurality of protrusions at an outer surface of the rubber cap and integral to the rubber cap, (ii) a plurality of lockable cavities at the outer surface of the rubber cap and integral to the rubber cap, or (iii) a combination of (i) and (ii), wherein each lockable cavity is at least partially defined by a lip that protrudes into the lockable cavity, and wherein the lip defines an opening of the lockable cavity; a supporting carcass positioned inward from the rubber cap along the radial direction; and two sidewalls that extend inward along the radial direction from axial outer edges of the rubber cap.

Embodiment 22. The body of Embodiment 21, wherein at least one of the plurality of protrusions have a radial cross-sectional shape, when separated from the tread belt, of: a minor-arc, a semi-circle, a major-arc, a rectangle, a rounded-rectangle, or a trapezoid.

Embodiment 23. The body of any one of Embodiments 21 and 22, wherein at least one of the plurality of lockable cavities have a radial cross-sectional shape of: a minor-arc, a semi-circle, a major-arc, a trapezoid, a squared-trapezoid, or a diamond.

Embodiment 24. The body of any one of Embodiments 21 through 23, wherein a number of the plurality of protrusions or the plurality of lockable cavities is 10 to 10,000.

Embodiment 25. The body of any one of Embodiments 21 through 24, wherein the plurality of protrusions or the plurality of lockable cavities are arranged in a pattern that comprises one or more straight lines along the circumference of the body and the tread belt and/or a hexagonal close-packed pattern.

Embodiment 26. The body of any one of Embodiments 21 through 25, wherein a spacing between individual protrusions is 0.5 cm to 10 cm.

Embodiment 27. The body of any one of Embodiments 21 through 26, wherein a spacing between individual lockable cavities is 0.5 cm to 10 cm.

Embodiment 28. The body of any one of Embodiments 21 through 27, wherein a maximum diameter of at least one of the plurality of protrusions is 0.5 cm to 3 cm.

Embodiment 29. The body of any one of Embodiments 21 through 28, wherein a diameter of an opening of at least one of the plurality of lockable cavities is 0.5 cm to 2 cm.

Embodiment 30. The body of any one of Embodiments 21 through 29, wherein a maximum diameter of at least one of the plurality of lockable cavities is 0.6 cm to 3 cm.

Embodiment 31. The body of any one of Embodiments 21 through 30, wherein a maximum depth of at least one of the plurality of lockable cavities is 0.5 cm to 3 cm.

Embodiment 32. The body of any one of Embodiments 21 through 31 further comprising: a rubber innerliner positioned inward along the radial direction from the supporting carcass and inward along an axial direction of the two-piece tire from the two sidewalls.

Embodiment 33. The body of Embodiment 32 further comprising: a sealing layer between the supporting carcass and the rubber innerliner.

Embodiment 34. The body of any one of Embodiments 13 through 31 further comprising: a barrier layer positioned inward along the radial direction from the supporting carcass and positioned inward along an axial direction of the two-piece tire from the two sidewalls.

Embodiment 35. The body of Embodiment 34 further comprising: a sealing layer between the supporting carcass and the barrier layer.

Embodiment 36. A tread belt for a two-piece tire comprising: an outer surface and an inner surface as opposing surfaces of the tread belt; a tread at the outer surface of the tread belt; and (i) a plurality of protrusions at the inner surface of the tread belt and integral to the tread belt, (ii) a plurality of lockable cavities at the inner surface of the tread belt and integral to the tread belt, or (iii) a combination of (i) and (ii), wherein each lockable cavity is at least partially defined by a lip that protrudes into the lockable cavity, and wherein the lip defines an opening of the lockable cavity.

Embodiment 37. The tread belt of Embodiment 36, wherein at least one of the plurality of protrusions have a radial cross-sectional shape, when separated from the tread belt, of: a minor-arc, a semi-circle, a major-arc, a rectangle, a rounded-rectangle, or a trapezoid.

Embodiment 38. The tread belt of any one of Embodiments 36 and 37, wherein at least one of the plurality of lockable cavities have a radial cross-sectional shape of: a minor-arc, a semi-circle, a major-arc, a trapezoid, a squared-trapezoid, or a diamond.

Embodiment 39. The tread belt of any one of Embodiments 36 through 38, wherein a number of the plurality of protrusions or the plurality of lockable cavities is 10 to 10,000.

Embodiment 40. The tread belt of any one of Embodiments 36 through 39, wherein the plurality of protrusions or the plurality of lockable cavities are arranged in a pattern that comprises one or more straight lines along the circumference of the body and the tread belt and/or a hexagonal close-packed pattern.

Embodiment 41. The tread belt of any one of Embodiments 36 through 40, wherein a spacing between individual protrusions is 0.5 cm to 10 cm.

Embodiment 42. The tread belt of any one of Embodiments 36 through -41, wherein a spacing between individual lockable cavities is 0.5 cm to 10 cm.

Embodiment 43. The tread belt of any one of Embodiments 36 through 42, wherein a maximum diameter of at least one of the plurality of protrusions is 0.5 cm to 3 cm.

Embodiment 44. The tread belt of any one of Embodiments 36 through 43, wherein a diameter of an opening of at least one of the plurality of lockable cavities is 0.5 cm to 2 cm.

Embodiment 45. The tread belt of any one of Embodiments 36 through 44, wherein a maximum diameter of at least one of the plurality of lockable cavities is 0.6 cm to 3 cm.

Embodiment 46. The tread belt of any one of Embodiments 36 through 45, wherein a maximum depth of at least one of the plurality of lockable cavities is 0.5 cm to 3 cm.

Embodiment 47. The tread belt of any one of Embodiments 36 through 46, wherein the tread belt has a maximum thickness of about 1 inch to about 3 inches.

Embodiment 48. The tread belt of any one of Embodiments 36 through 47, wherein the tread has a summer tread block, a winter tread block, or an all-season tread block.

Embodiment 49. A method comprising: applying a force to a tread belt in an outwardly radial direction, the tread belt comprising a tread at an outer surface of the tread belt and a first portion of a plurality of locking mechanisms at an inner surface of the tread belt and integral to the tread belt; positioning a body within a circumference of the tread belt, the body comprising a rubber cap located in an outermost portion of the body facing the inner surface of the tread belt, the rubber cap comprising a second portion of the plurality of locking mechanisms that (a) correspond to the first portion of the plurality of locking mechanisms, (b) are at an outer surface of the rubber cap, and (c) are integral to the rubber cap; wherein each of the plurality of locking mechanisms comprises a protrusion capable of extending into a lockable cavity via an opening, each lockable cavity being at least partially defined by a lip that protrudes into the lockable cavity, the lip defining the opening of the lockable cavity; wherein, for at least one of the plurality of locking mechanisms, (i) the first portion is the protrusion and the second portion is the lockable cavity or (ii) the first portion is the lockable cavity and the second portion is the protrusion; aligning the first and second portions of the plurality of locking mechanisms; removing the force so as to cause the protrusion to extend into the lockable cavity and the inner surface of the tread belt to engage the outer surface of the rubber cap to form a direct-contact interface therebetween.

Embodiment 50. The method of Embodiment 49, wherein the protrusion fills at least 90 percent of a volume of the lockable cavity corresponding thereto.

Embodiment 51. The method of any one of Embodiments 49 and 50, wherein no adhesive is present at the direct-contact interface.

Embodiment 52. The method of any one of Embodiments 49 through 51, wherein a diameter of the opening is smaller than a maximum diameter of the respective lockable cavity.

Embodiment 53. The method of any one of Embodiments 49 through 52, wherein a diameter of the opening is equal to or smaller than a maximum diameter of a protrusion extending into the respective lockable cavity.

Embodiment 54. The method of any one of Embodiments 49 through 53, wherein, for at least one of plurality of locking mechanisms, the protrusion has a radial cross-sectional shape, when separated from the tread belt, of: a minor-arc, a semi-circle, a major-arc, a rectangle, a rounded-rectangle, or a trapezoid.

Embodiment 55. The method of any one of Embodiments 49 through 54, wherein, for at least one of plurality of locking mechanisms, the lockable cavity has a radial cross-sectional shape of: a minor-arc, a semi-circle, a major-arc, a trapezoid, a squared-trapezoid, or a diamond.

Embodiment 56. The method of any one of Embodiments 49 through 55, wherein a number of the plurality of locking mechanisms is 10 to 10,000.

Embodiment 57. The method of any one of Embodiments 49 through 56, wherein the plurality of locking mechanisms are arranged in a pattern that comprises one or more straight lines along the circumference of the body and the tread belt and/or a hexagonal close-packed pattern.

Embodiment 58. The method of any one of Embodiments 49 through 57, wherein a spacing between the protrusions is 0.5 cm to 10 cm.

Embodiment 59 The method of any one of Embodiments 49 through 58, wherein a spacing between the lockable cavities is 0.5 cm to 10 cm.

Embodiment 60. The method of any one of Embodiments 49 through 59, wherein a maximum diameter of the protrusion is 0.5 cm to 3 cm.

Embodiment 61. The method of any one of Embodiments 49 through 60, wherein a diameter of an opening of the lockable cavity is 0.5 cm to 2 cm.

Embodiment 62. The method of any one of Embodiments 49 through 61, wherein a maximum diameter of the lockable cavity is 0.6 cm to 3 cm.

Embodiment 63. The method of any one of Embodiments 49 through 62, wherein a maximum depth of the lockable cavity is 0.5 cm to 3 cm.

Embodiment 64. The method of any one of Embodiments 49 through 63, wherein the tread belt has a maximum thickness of about 1 inch to about 3 inches.

Embodiment 65. The method of any one of Embodiments 49 through 64, wherein the tread has a summer tread block, a winter tread block, or an all-season tread block.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present invention are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A two-piece tire comprising:
a tread belt and a body connected by a plurality of locking mechanisms, the tread belt comprising a tread at an outer surface of the tread belt, and the body comprising a rubber cap located at an outermost portion of the body along a radial direction of the two-piece tire;
wherein each of the plurality of locking mechanisms comprises a protrusion that extends into a lockable cavity via an opening, each lockable cavity being at least partially defined by a lip that protrudes into the lockable cavity;
wherein the lip defines the opening of the lockable cavity;
wherein, for at least one of the plurality of locking mechanisms, either (i) the protrusion is integral to an inner surface of the tread belt and the lockable cavity is integral to an outer surface of the rubber cap or (ii) the protrusion is integral to the outer surface of the rubber cap and the lockable cavity is integral to the inner surface of the tread belt; and
wherein the inner surface of the tread and the outer surface of the rubber cap form a direct contact interface.

2. The two-piece tire of claim 1, wherein each of the plurality of protrusions fill at least 90 percent of a volume each of the plurality of lockable cavities corresponding thereto.

3. The two-piece tire of claim 1, wherein no adhesive is present at the direct contact interface.

4. The two-piece tire of claim 1, wherein, for at least one of the plurality of locking mechanisms, the lockable cavity has a radial cross-sectional shape of: a minor-arc, a semi-circle, a major-arc, a trapezoid, a squared-trapezoid, or a diamond.

5. The two-piece tire of claim 1, wherein, for at least one of the plurality of locking mechanisms, the protrusion has a radial cross-sectional shape, when separated from the tread belt, of: a minor-arc, a semi-circle, a major-arc, a rectangle, a rounded-rectangle, or a trapezoid.

6. The two-piece tire of claim 1, wherein the tread belt has a maximum thickness of about 1 inch to about 3 inches.

7. The two-piece tire of claim 1, wherein a maximum diameter of the protrusion is 0.5 cm to 3 cm.

8. The two-piece tire of claim 1, wherein a diameter of an opening of the lockable cavity is 0.5 cm to 2 cm.

9. The two-piece tire of claim 1, wherein a maximum diameter of the lockable cavity is 0.6 cm to 3 cm.

10. The two-piece tire of claim 1, wherein a maximum depth of the lockable cavity is 0.5 cm to 3 cm.

11. The two-piece tire of claim 1, wherein the body further comprises: a supporting carcass positioned inward along the radial direction from the rubber cap and abutting the rubber cap, two sidewalls that extend inward along the radial direction from axial outer edges of the rubber cap, and a rubber innerliner positioned inward along the radial direction from the supporting carcass and inward along an axial direction of the two-piece tire from the two sidewalls.

12. The two-piece tire of claim 1, wherein the body further comprises a supporting carcass positioned inward along the radial direction from the rubber cap and abutting the rubber cap, two sidewalls that extend inward along the radial direction from axial outer edges of the rubber cap, and a barrier layer positioned inward along the radial direction from the supporting carcass and inward along an axial direction along an axial direction of the two-piece tire from the two sidewalls.

13. A body for a two-piece tire comprising:
a rubber cap located in an outermost portion of the body along a radial direction of the two-piece tire, the rubber cap comprising (i) a plurality of protrusions at an outer surface of the rubber cap and integral to the rubber cap, (ii) a plurality of lockable cavities at the outer surface of the rubber cap and integral to the rubber cap, or (iii) a combination of (i) and (ii), wherein each lockable cavity is at least partially defined by a lip that protrudes into the lockable cavity, and wherein the lip defines an opening of the lockable cavity;
a supporting carcass positioned inward from the rubber cap along the radial direction; and
two sidewalls that extend inward along the radial direction from axial outer edges of the rubber cap.

14. The body of claim 13, wherein at least one of the plurality of protrusions have a radial cross-sectional shape, when separated from the tread belt, of: a minor-arc, a semi-circle, a major-arc, a rectangle, a rounded-rectangle, or a trapezoid.

15. The body of claim 13, wherein at least one of the plurality of lockable cavities have a radial cross-sectional shape of: a minor-arc, a semi-circle, a major-arc, a trapezoid, a squared-trapezoid, or a diamond.

16. The body of claim 13 further comprising a rubber innerliner positioned inward along the radial direction from the supporting carcass and inward along an axial direction of the two-piece tire from the two sidewalls.

17. The body of claim 13 further comprising a barrier layer positioned inward along the radial direction from the supporting carcass and positioned inward along an axial direction of the two-piece tire from the two sidewalls.

18. A tread belt for a two-piece tire comprising:
an outer surface and an inner surface as opposing surfaces of the tread belt;
a tread at the outer surface of the tread belt; and
(i) a plurality of protrusions at the inner surface of the tread belt and integral to the tread belt, (ii) a plurality of lockable cavities at the inner surface of the tread belt and integral to the tread belt, or (iii) a combination of (i) and (ii), wherein each lockable cavity is at least partially defined by a lip that protrudes into the lockable cavity, and wherein the lip defines an opening of the lockable cavity.

19. The tread belt of claim 18, wherein at least one of the plurality of protrusions have a radial cross-sectional shape, when separated from the tread belt, of: a minor-arc, a semi-circle, a major-arc, a rectangle, a rounded-rectangle, or a trapezoid.

20. The tread belt of claim 18, wherein at least one of the plurality of lockable cavities have a radial cross-sectional shape of: a minor-arc, a semi-circle, a major-arc, a trapezoid, a squared-trapezoid, or a diamond.
